(19) United States
(12) Patent Application Publication
(10) Pub. No.: US 2026/0340985 A1
(43) Pub. Date: Oct. 29, 2026

(54) APPARATUS FOR COMPARING USER INTERFACES OF APPLICATIONS USING ARTIFICIAL INTELLIGENCE AND OPERATING METHOD THEREOF

(71) Applicant: KWANGWOON UNIVERSITY INDUSTRY-ACADEMIC COLLABORATION FOUNDATION, Seoul (KR)

(72) Inventors: Hyun Kyung KIM, Seoul (KR); Ha Yun PARK, Seoul (KR)

(73) Assignee: KWANGWOON UNIVERSITY INDUSTRY-ACADEMIC COLLABORATION FOUNDATION, Seoul (KR)

(21) Appl. No.: 19/437,691

(22) Filed: Dec. 31, 2025

(30) Foreign Application Priority Data
Apr. 28, 2025 (KR) 10-2025-0055709

(51) Int. Cl. G06V 10/74; G06V 10/56; G06V 10/75; G06V 10/762; G06V 30/18; G06V 30/19

(52) U.S. Cl. CPC G06V 10/761; G06V 10/56; G06V 10/751; G06V 10/762; G06V 30/18105; G06V 30/19093; G06V 2201/02

(57) ABSTRACT

An operating method of a user interface comparison apparatus including a controller, the operating method comprising: acquiring, by the controller, screen information of a user interface displayed on an application screen; acquiring layout information including at least one of a location, a size, or a type of at least one item included in the screen information; acquiring a layout feature vector based on the layout information; acquiring first layout feature information, for the application, including the layout information and the layout feature vector; acquiring second layout feature information based on a different application screen from the application; and acquiring layout similarity information based on the first layout feature information and the second layout feature information.

### CROSS-REFERENCE TO RELATED APPLICATION

This application claims priority to and the benefit of Korean Patent Application No. 10-2025-0055709, filed on Apr. 28, 2025, the disclosure of which is incorporated herein by reference in its entirety.

### FIELD OF INVENTION

The present disclosure relates to a user interface comparison apparatus for comparing user interfaces of applications using artificial intelligence, and an operating method of the user interface comparison apparatus. More specifically, the user interface comparison apparatus compares layout, color, or text to acquire similarity of user interfaces with high accuracy.

### BACKGROUND

The user interface (UI) of an application (hereinafter referred to as an "app") plays the most important role in a user's interaction with the app. Particularly, as the mobile app market has rapidly grown recently, apps in various fields are being released, and due to this, the importance of the user experience (UX) is being further emphasized.

Generally, the UI design of an app aims to provide clear information delivery and intuitive usability to the user, and in this process, the similarity between apps tends to increase. While this is also intended to provide a consistent experience to the user, excessive similarity between app designs can potentially lead to plagiarism issues. In practice, as the similarity of mobile app UI designs increases, it is gradually becoming more difficult to distinguish between original designs and plagiarized designs.

In the related art, there was often reliance on subjective evaluation due to the absence of specific and objective criteria for evaluating the similarity of app UI designs or determining plagiarism. Particularly, in legal dispute situations, it was difficult to objectively prove design plagiarism, which caused a problem of consuming a lot of time and cost.

Existing studies have mainly focused on technologies such as UI dataset configuration, UI design example retrieval, and UI item detection. However, there has been a lack of research that can objectively judge by directly evaluating or quantifying the similarity between UI designs. For example, studies have been conducted to automatically detect items such as buttons and icons on a mobile app screen, or to derive design ideas based on data for specific UI items. However, these approaches are mainly for design generation or analysis and have limitations in evaluating and comparing similarity.

Accordingly, there is a continuing need for a method capable of protecting original designs and preventing plagiarism by objectively and quantitatively evaluating the similarity of mobile app UI designs.

### SUMMARY OF THE INVENTION

According to an embodiment of the present disclosure, an operating method of a user interface comparison apparatus including a controller, the operating method comprising: acquiring, by the controller, screen information of a user interface displayed on an application screen; acquiring layout information including at least one of a location, a size, or a type of at least one item included in the screen information; acquiring a layout feature vector based on the layout information; acquiring first layout feature information, for the application, including the layout information and the layout feature vector; acquiring second layout feature information based on a different application screen from the application; and acquiring layout similarity information based on the first layout feature information and the second layout feature information.

In the operating method of the user interface comparison apparatus according to an embodiment of the present disclosure, the acquiring the layout information comprises: acquiring the layout information by applying the screen information, which includes a capture image of the application screen, to a layout machine learning model, and the acquiring the layout feature vector comprises: acquiring the layout feature vector by applying the layout information to a feature determination machine learning model.

In the operating method of the user interface comparison apparatus according to an embodiment of the present disclosure, the layout machine learning model is a YOLO-based machine learning model, and the feature determination machine learning model is an autoencoder-based machine learning model.

In the operating method of the user interface comparison apparatus according to an embodiment of the present disclosure, the acquiring the layout similarity information based on the first layout feature information and the second layout feature information comprises: acquiring first layout similarity information by comparing layout information included in the first layout feature information and layout information included in the second layout feature information; acquiring second layout similarity information by comparing a feature vector included in the first layout feature information and a feature vector included in the second layout feature information; and acquiring the layout similarity information by calculating a weighted average of the first layout similarity information and the second layout similarity information with a predetermined layout weight.

The operating method of the user interface comparison apparatus according to an embodiment of the present disclosure may further comprise: acquiring color information of a plurality of pixels included in the screen information; clustering the color information into a plurality of groups of a predetermined number of groups; determining a group having a largest number of pixels among the plurality of groups as a background group; determining remaining groups, excluding the background group from the plurality of groups, as at least one main group; acquiring a background ratio indicating a ratio of pixels included in the background group among the plurality of pixels; acquiring a representative background color, which is a representative color of the background group; acquiring at least one main color ratio indicating a ratio of pixels included in each of the at least one main group among the plurality of pixels; and acquiring at least one representative main color by respectively acquiring a representative color of the at least one main group.

The operating method of the user interface comparison apparatus according to an embodiment of the present disclosure may further comprise: selecting at least one text layout information for which a type of item is text from the layout information; acquiring at least one text color information based on the at least one text layout information; clustering the at least one text color information into a plurality of text area groups of a predetermined number of text area groups; determining a group having a highest pixel ratio among the plurality of text area groups as a text color group; acquiring a text color ratio indicating a ratio of pixels included in the text color group among the plurality of pixels; and acquiring a representative text color, which is a representative color of the text color group.

In the operating method of the user interface comparison apparatus according to an embodiment of the present disclosure, the acquiring the at least one text color information comprises: selecting, based on one text layout information among the at least one text layout information, a color of at least one pixel located at an edge of an area of text as a text background color; and acquiring a color having a highest ratio, excluding the text background color, from the area of the text as the text color information.

The operating method of the user interface comparison apparatus according to an embodiment of the present disclosure may comprise: acquiring the background ratio, the representative background color, the at least one main color ratio, the at least one representative main color, the text color ratio, and the representative text color for the application as first color feature information; acquiring background ratio, representative background color, at least one main color ratio, at least one representative main color, text color ratio, and representative text color for the different application as second color feature information; and acquiring color similarity information based on the first color feature information and the second color feature information.

In the operating method of the user interface comparison apparatus according to an embodiment of the present disclosure, the acquiring the color similarity information comprises: acquiring first color similarity information by comparing at least one of the background ratio and the representative background color included in the first color feature information with at least one of the background ratio and the representative background color included in the second color feature information; acquiring second color similarity information by comparing at least one of the at least one main color ratio and the at least one representative main color included in the first color feature information with at least one of the at least one main color ratio and the at least one representative main color included in the second color feature information; acquiring third color similarity information by comparing at least one of the text color ratio and the representative text color included in the first color feature information with at least one of the text color ratio and the representative text color included in the second color feature information; and acquiring the color similarity information by calculating a weighted average of the first color similarity information, the second color similarity information, and the third color similarity information with a predetermined color weight.

The operating method of the user interface comparison apparatus according to an embodiment of the present disclosure may further comprise: selecting text layout information for which a type of item is text from the layout information; acquiring at least one of text information and text location information based on the text layout information; and acquiring a text feature vector based on the at least one of the text information and the text location information.

The operating method of the user interface comparison apparatus according to an embodiment of the present disclosure may further comprise: acquiring the text feature vector for the application as first text feature information; acquiring a text feature vector for the different application as second text feature information; and acquiring text similarity information based on the first text feature information and the second text feature information.

The operating method of the user interface comparison apparatus according to an embodiment of the present disclosure may further comprise: determining final similarity information of the application and the different application by calculating a weighted average of the layout similarity information, the color similarity information, and the text similarity information with a predetermined final weight.

According to an embodiment of the present disclosure, an operating method of a user interface comparison apparatus including a controller, the operating method comprising: acquiring, by the controller, screen information of a user interface displayed on an application screen; acquiring color information of a plurality of pixels included in the screen information; clustering the color information into a plurality of groups of a predetermined number of groups; determining a group having a largest number of pixels among the plurality of groups as a background group; determining remaining groups, excluding the background group from the plurality of groups, as at least one main group; acquiring a background ratio indicating a ratio of pixels included in the background group among the plurality of pixels; acquiring a representative background color, which is a representative color of the background group; acquiring at least one main color ratio indicating a ratio of pixels included in each of the at least one main group among the plurality of pixels; and acquiring at least one representative main color by respectively acquiring a representative color of the at least one main group.

According to an embodiment of the present disclosure, an operating method of a user interface comparison apparatus including a controller, the operating method comprising: acquiring, by the controller, screen information of a user interface displayed on an application screen; acquiring layout information including at least one of a location, a size, or a type of at least one item included in the screen information; selecting text layout information for which a type of item is text from the layout information; acquiring at least one of text information and text location information based on the text layout information; and acquiring a text feature vector based on the at least one of the text information and the text location information.

According to an embodiment of the present disclosure, a user interface comparison apparatus, comprising: a controller including a processor and a memory, wherein the processor, based on instructions stored in the memory, is configured to: acquire screen information of a user interface displayed on an application screen, acquire layout information including at least one of a location, a size, or a type of at least one item included in the screen information, acquire a layout feature vector based on the layout information, acquire first layout feature information for the application, the first layout feature information including the layout information and the layout feature vector, acquire second layout feature information based on an application screen different from the application, and acquire layout similarity information based on the first layout feature information and the second layout feature information.

Additionally, a program for implementing the operating method of the user interface comparison apparatus as described above may be recorded on a computer-readable recording medium.

### BRIEF DESCRIPTION OF THE DRAWINGS

FIG. 1 is a diagram illustrating a user interface comparison apparatus according to an embodiment of the present disclosure.

FIG. 2 is a diagram for explaining a controller of the present disclosure.

FIG. 3 is a flowchart for explaining an operating method of the user interface comparison apparatus according to an embodiment of the present disclosure.

FIG. 4 is a diagram for explaining an operation of the controller according to an embodiment of the present disclosure.

FIG. 5 is a diagram for explaining an operation of the controller according to an embodiment of the present disclosure.

FIG. 6 is a flowchart illustrating an operating method of the user interface comparison apparatus according to an embodiment of the present disclosure.

FIG. 7 is a diagram for explaining an operating method of the user interface comparison apparatus according to an embodiment of the present disclosure.

FIG. 8 is a flowchart illustrating an operating method of the user interface comparison apparatus according to an embodiment of the present disclosure.

FIG. 9 is a diagram for explaining an operating method of the user interface comparison apparatus according to an embodiment of the present disclosure.

FIG. 10 is a flowchart illustrating an operating method of the user interface comparison apparatus according to an embodiment of the present disclosure.

FIG. 11 is a diagram for explaining an operating method of the user interface comparison apparatus according to an embodiment of the present disclosure.

FIG. 12 is a flowchart illustrating an operating method of the user interface comparison apparatus according to an embodiment of the present disclosure.

FIG. 13 is a flowchart explaining an operation of the user interface comparison apparatus according to an embodiment of the present disclosure.

FIG. 14 is a flowchart explaining an operation of the user interface comparison apparatus according to an embodiment of the present disclosure.

FIG. 15 is a diagram for explaining an operation of the user interface comparison apparatus according to an embodiment of the present disclosure.

FIG. 16 is a flowchart illustrating an operating method of the user interface comparison apparatus according to an embodiment of the present disclosure.

FIG. 17 is a diagram for explaining an operating method of the user interface comparison apparatus according to an embodiment of the present disclosure.

FIG. 18 is a diagram for explaining an operating method of the user interface comparison apparatus according to an embodiment of the present disclosure.

FIG. 19 is a flowchart illustrating an operating method of the user interface comparison apparatus according to an embodiment of the present disclosure.

FIGS. 20A and 20B are diagrams for showing the effects of the user interface comparison apparatus according to an embodiment of the present disclosure.

### DETAILED DESCRIPTION OF EXEMPLARY EMBODIMENTS

Advantages and features of the disclosed embodiments and methods of achieving them will become apparent with reference to the embodiments described below in conjunction with the accompanying drawings. However, the present disclosure is not limited to the embodiments disclosed below, but may be implemented in various different forms, and these embodiments are provided only to complete the disclosure and to fully inform those of ordinary skill in the art to which the present disclosure pertains of the scope of the invention.

Hereinafter, terms used in this specification will be briefly described, and the disclosed embodiments will be described in detail.

The terms used in this specification have been selected as general terms that are widely used at present, if possible, in consideration of the functions in the present disclosure, but this may vary according to the intention of technicians in the relevant field, judicial precedents, the emergence of new technologies, etc. In addition, in specific cases, there are terms arbitrarily selected by the applicant, and in this case, the meaning thereof will be described in detail in the corresponding description part of the invention. Therefore, the terms used in the present disclosure should be defined based on the meaning of the terms and the overall content of the present disclosure, rather than simply the names of the terms.

In this specification, the singular expression includes the plural expression unless the context clearly indicates otherwise. In addition, the plural expression includes the singular expression unless the context clearly indicates otherwise.

Throughout the specification, when a part "includes" a component, it means that it may further include other components, not excluding other components, unless there is a particularly contrary description.

In addition, the term "unit" used in the specification means a software or hardware component, and the "unit" performs certain roles. However, the "unit" is not limited to software or hardware. The "unit" may be configured to be in an addressable storage medium and may be configured to reproduce one or more processors. Accordingly, as an example, a "unit" includes components such as software components, object-oriented software components, class components, and task components, and processes, functions, attributes, procedures, subroutines, segments of program code, drivers, firmware, microcode, circuits, data, databases, data structures, tables, arrays, and variables. The functions provided in the components and "units" may be combined into a smaller number of components and "units" or may be further separated into additional components and "units".

According to an embodiment of the present disclosure, a "unit" may be implemented as a processor and a memory. The term "processor" should be interpreted broadly to include a general-purpose processor, a central processing unit (CPU), a microprocessor, a digital signal processor (DSP), a controller, a microcontroller, a state machine, etc. In some circumstances, a "processor" may refer to an application specific integrated circuit (ASIC), a programmable logic device (PLD), a field programmable gate array (FPGA), etc. The term "processor" may also refer to a combination of processing devices, such as, for example, a combination of a DSP and a microprocessor, a combination of a plurality of microprocessors, a combination of one or more microprocessors combined with a DSP core, or a combination of any other such configurations.

The term "memory" should be interpreted broadly to include any electronic component capable of storing electronic information. The term memory may refer to various types of processor-readable media such as random access memory (RAM), read-only memory (ROM), non-volatile random access memory (NVRAM), programmable read-only memory (PROM), erasable-programmable read-only memory (EPROM), electrically erasable PROM (EEPROM), flash memory, magnetic or optical data storage, registers, etc. A memory is said to be in electronic communication with a processor if the processor can read information from and/or write information to the memory. A memory integrated into a processor is in electronic communication with the processor.

Hereinafter, embodiments will be described in detail with reference to the accompanying drawings so that those of ordinary skill in the art to which the present disclosure pertains can easily practice them. And in the drawings, parts unrelated to the description are omitted to clearly explain the present disclosure.

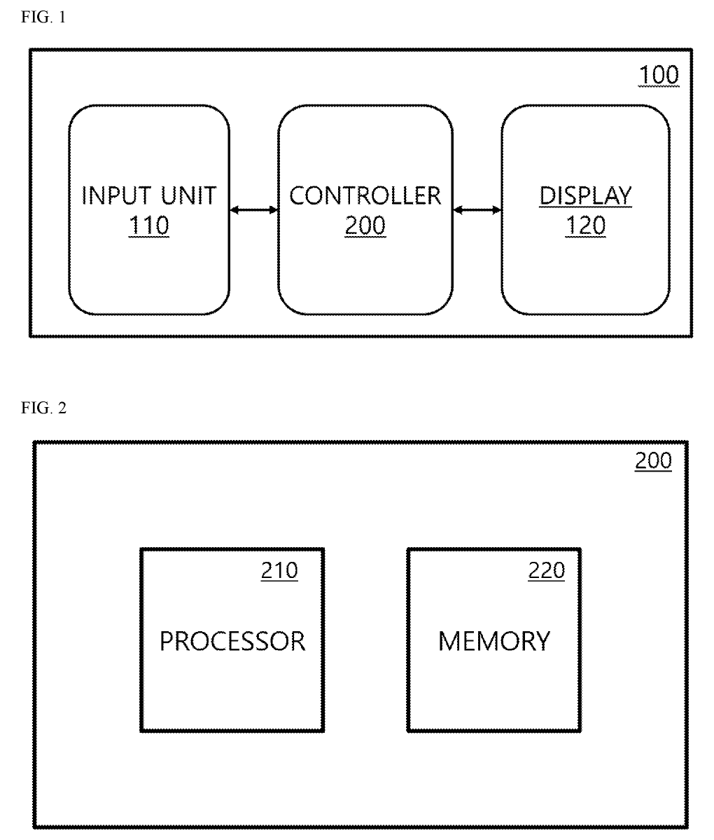

FIG. 1 is a diagram illustrating a user interface comparison apparatus according to an embodiment of the present disclosure.

The user interface comparison apparatus 100 may include an input unit 110, a controller 200, and a display 120. The user interface comparison apparatus 100 may be an apparatus for analyzing the similarity of a plurality of applications. The user interface comparison apparatus 100 may be implemented as a PC, smartphone, tablet, or laptop computer.

The input unit 110 may be a device for receiving input from a user. The input unit 110 may include at least one of a touchscreen, a keyboard, a user gaze input unit, and a mouse. In addition, the input unit 110 may be a configuration for receiving screen information. The input unit 110 may include a camera or a communication unit. The camera included in the input unit may capture a screen on which an application is executed to acquire screen information. In addition, the communication unit included in the input unit 110 may acquire screen information from another device. However, the present disclosure is not limited thereto, and the input unit may acquire screen information by capturing the screen displayed by the user interface comparison apparatus 100 based on user input.

The display 120 may be a configuration for displaying an image. The display 120 may display screen information to be compared. In addition, the display 120 may display an analysis result of the user interface comparison apparatus 100.

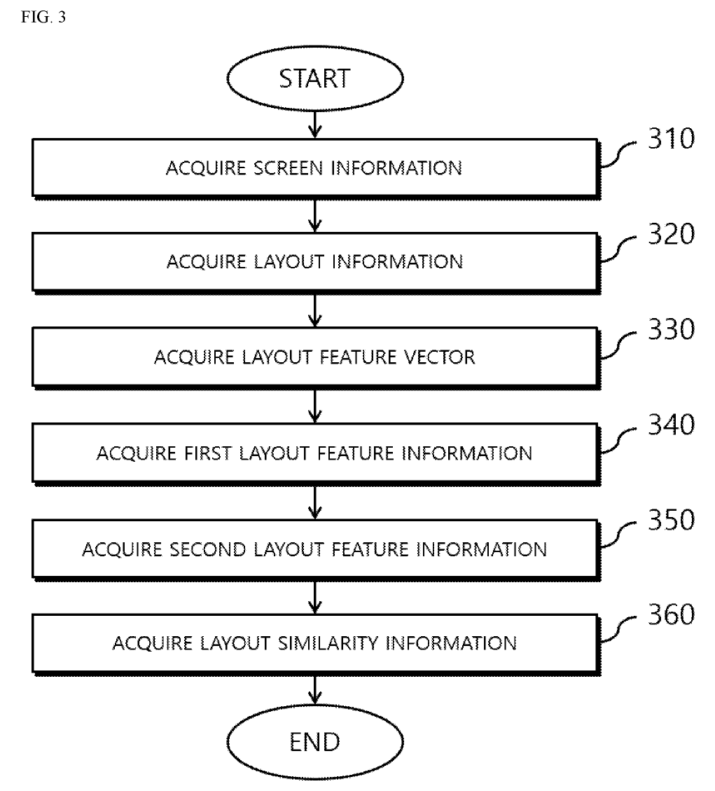

The controller 200 may be a device for controlling the operation of the user interface comparison apparatus 100. Referring to FIG. 2 to describe the controller 200.

FIG. 2 is a diagram for explaining the controller of the present disclosure.

The controller 200 may include a processor 210 and a memory 220. The processor 210 may perform operations based on instructions stored in the memory 220. However, the present disclosure is not limited thereto, and the processor 210 may be set to output a preset signal to an output line for a preset time based on an input signal.

Hereinafter, the operation of the controller 200 will be described in more detail.

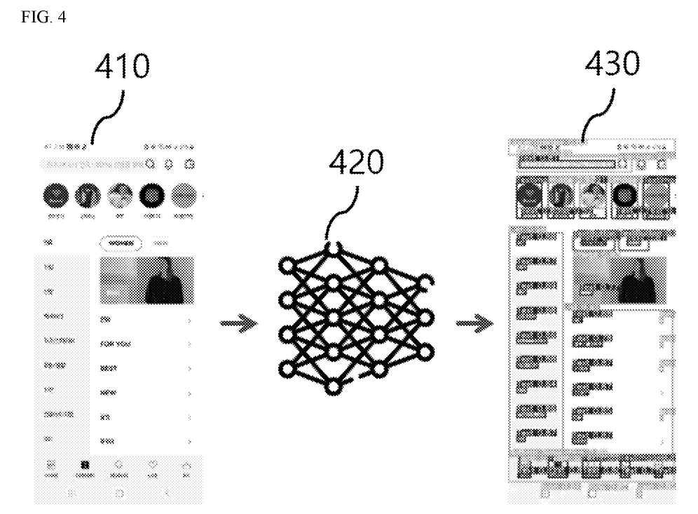

FIG. 3 is a flowchart for explaining an operating method of the user interface comparison apparatus according to an embodiment of the present disclosure.

The user interface comparison apparatus 100 may be an apparatus for comparing user interfaces of applications. The user interface comparison apparatus 100 includes the controller 200 and may perform the following operations.

The controller 200 may perform a step 310 of acquiring screen information of a user interface displayed on an application screen. The screen information may be a still image. However, the present disclosure is not limited thereto, and the screen may be a moving image. The screen information may be acquired by capturing a screen on which an application is executed or by shooting with a camera. However, the present disclosure is not limited thereto. The user interface of an application may be implemented using a markup language such as HTML or XML. A markup (code) implemented in a markup language may indicate a location, shape, size, color, or font of at least one item displayed on the screen. The controller 200 may acquire such markup as screen information.

The controller 200 may perform a step 320 of acquiring layout information including at least one of a location, a size, or a type of at least one item included in the screen information. In the present disclosure, an item may mean a component of a UI (user interface).

The type of item included in the layout information may include a background image, text, checkbox, card, button, text input, image, Drawer, or list. The location of the item included in the layout information may be a coordinate value indicating the location where the item is displayed on the screen. The location of the item may be represented by the coordinate value of the upper-left pixel of the item. The location of the item may be represented by the coordinate value of the upper-left pixel of the bounding box including the item. However, the present disclosure is not limited thereto. The size of the item included in the layout information may indicate the size of the bounding box including the item. The size of the item may be expressed by the coordinates of the upper-left side and the lower-right side of the bounding box. However, the present disclosure is not limited thereto, and it may be expressed by width and height.

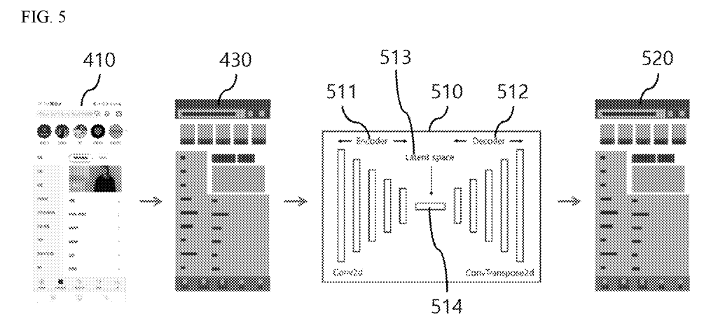

When the screen information is an image, the controller 200 may use a machine learning model to acquire the layout information based on the screen information. Hereinafter, referring to FIG. 4 to describe the machine learning model in detail.

FIG. 4 is a diagram for explaining an operation of the controller according to an embodiment of the present disclosure.

Referring to FIG. 4, the step 320 of acquiring layout information may include the following steps. The controller 200 may perform a step of acquiring the layout information 430 by applying the screen information 410, which includes a capture image of the application screen, to a layout machine learning model 420. The capture image may be acquired by shooting using a camera or by capturing the screen displayed on the display 120. The layout machine learning model 420 may be a model generated by supervised learning. For example, the layout machine learning model 420 may be a YOLO-based machine learning model. However, the present disclosure is not limited thereto, and the layout machine learning model may be generated by unsupervised learning. The layout information 430 may include at least one of a location, a size, or a type of an item.

In the present disclosure, it is described that the controller 200 acquires output information by applying input information to a machine learning model, but the present disclosure is not limited thereto. The controller 200 may transmit the input information to an external server, the server may generate output information by applying the input information to the machine learning model, and the server may transmit the output information to the controller 200.

The controller 200 may generate the layout machine learning model in advance before performing step 320. The layout machine learning model may be generated through the following process. In the present disclosure, it is described that the machine learning model is generated by the controller 200, but the present disclosure is not limited thereto. In practice, an external server, not the controller 200, may generate the machine learning model.

The controller 200 may acquire training screen information. The training screen information may be an image captured from the screen of the device. The training screen information may be data used for training. The controller 200 may acquire training layout information. The training layout information may be label information generated by a user or an automatic labeling device. The training layout information may be ground truth information. The training layout information may correspond one-to-one with the training screen information. The controller may generate the layout machine learning model by machine learning the correlation between the training screen information and the training layout information. The layout machine learning model may be trained based on, for example, YOLOv8.

When the screen information is implemented as markup, the controller 200 may derive the layout information based on the markup written in the markup language. However, the markup language may express the same item with various markups depending on the version or the type of markup language. In addition, even if the same markup is used, the location, size, or type of the item may be displayed differently for each device. Therefore, the controller 200 may acquire the layout information based on the screen information written in the markup language, but the layout information may be different from the content displayed on the actual device. Therefore, the controller 200 of the present disclosure may acquire the layout information using the screen information including the captured image. Accordingly, the similarity of the UI can be determined based on the actual screen displayed on the device.

Referring back to FIG. 3, the controller 200 may perform a step 330 of acquiring a layout feature vector based on the layout information. More specifically, the step 330 of acquiring the layout feature vector may include the following steps. The controller 200 may perform a step of acquiring the layout feature vector by applying the layout information to a feature determination machine learning model. The feature determination machine learning model may be an autoencoder-based machine learning model.

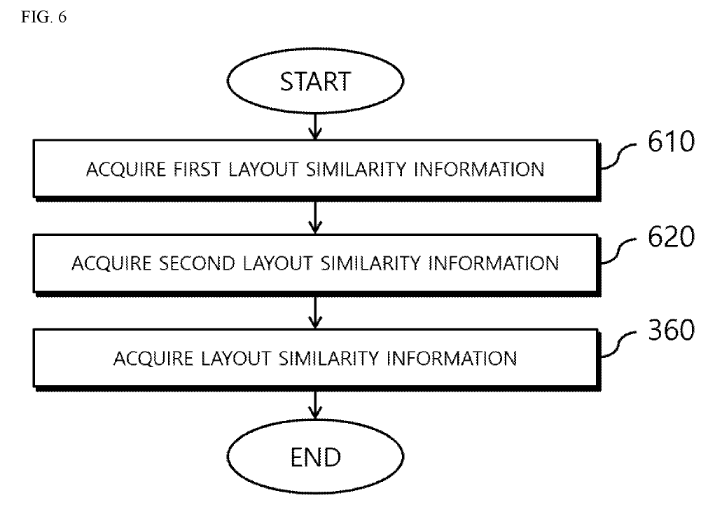

Referring briefly to FIG. 5 to describe the feature determination machine learning model.

FIG. 5 is a diagram for explaining an operation of the controller according to an embodiment of the present disclosure.

Referring to FIG. 5, the controller 200 may acquire the layout information 430 based on the capture image. The controller 200 may include an autoencoder 510. The autoencoder 510 may include an encoder 511 and a decoder 512. The controller 200 may acquire the layout feature vector 514 in the latent space 513 by compressing the layout information 430 using the encoder 511 included in the autoencoder. The controller 200 may restore the layout feature vector 514 to predicted layout information 520 using the decoder 512 of the autoencoder. The predicted layout information 520 may be very similar to the layout information 430. The feature determination machine learning model may be the encoder 511 of the autoencoder 510. The controller 200 may acquire the layout feature vector 514 by applying the layout information 430 to the feature determination machine learning model.

Referring back to FIG. 3, the controller 200 may perform a step 340 of acquiring first layout feature information, for the application, including the layout information and the layout feature vector. In addition, the controller 200 may perform a step 350 of acquiring second layout feature information based on a different application screen from the application. The controller 200 may compare the layout of the different application and the application. For comparison, the controller 200 may acquire the first layout feature information and the second layout feature information. The different application and the application may be different configurations. However, the application and the different application may be executed on the same device with a time difference, and the controller 200 may acquire the first layout feature information based on the screen on which the application is executed, and acquire the second layout feature information based on the screen on which the different application is executed.

The first layout feature information may include the layout information and the layout feature vector for the application. The layout information and the layout feature vector included in the first layout feature information may be information that implicitly includes the features of the UI of the application. The second layout feature information may include the layout information and the layout feature vector for the different application. The layout information and the layout feature vector included in the second layout feature information may be information that implicitly includes the features of the UI of the different application. Therefore, the controller 200 may compare the UI of the application and the different application by comparing the first layout feature information and the second layout feature information.

The controller 200 may perform a step 360 of acquiring layout similarity information based on the first layout feature information and the second layout feature information.

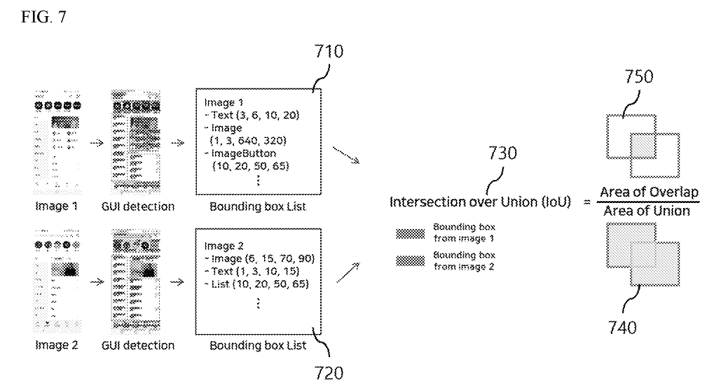

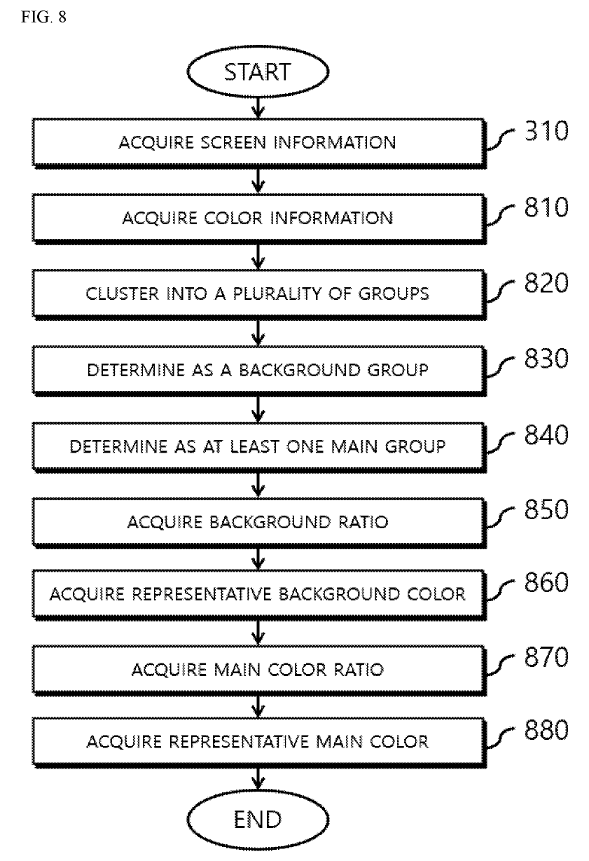

FIG. 6 is a flowchart illustrating an operating method of the user interface comparison apparatus according to an embodiment of the present disclosure. FIG. 7 is a diagram for explaining an operating method of the user interface comparison apparatus according to an embodiment of the present disclosure.

The step 360 of acquiring layout similarity information based on the first layout feature information and the second layout feature information may include the following steps.

The controller 200 may perform a step 610 of acquiring first layout similarity information 730 by comparing layout information 710 included in the first layout feature information and layout information 720 included in the second layout feature information. Step 610 may be to compare the layout information of different applications. The controller 200 may perform the following process to acquire the first layout similarity information 730. The controller 200 may acquire a union 740 of the area of the bounding box of the item included in the layout information 710 included in the first layout feature information and the area of the bounding box of the item included in the layout information 720 included in the second layout feature information. The controller 200 may acquire an intersection 750 of the area of the bounding box of the item included in the layout information 710 included in the first layout feature information and the area of the bounding box of the item included in the layout information 720 included in the second layout feature information. The controller 200 may acquire the first layout similarity information 730 by dividing the number of pixels included in the intersection 750 by the number of pixels included in the union 740. The first layout similarity information 730 being closer to 1 may indicate that the UI of the application and the UI of the different application match. The first layout similarity information 730 being closer to 0 may indicate that the UI of the application and the UI of the different application are different.

Referring to FIG. 6, the controller 200 may perform a step 620 of acquiring second layout similarity information by comparing a feature vector included in the first layout feature information and a feature vector included in the second layout feature information. The controller 200 may acquire the second layout similarity information based on cosine similarity. The second layout similarity information being closer to 1 may indicate that the UI of the application and the UI of the different application match. The second layout similarity information being closer to 0 may indicate that the UI of the application and the UI of the different application are unrelated.

The controller 200 may perform a step 360 of acquiring the layout similarity information by calculating a weighted average of the first layout similarity information and the second layout similarity information with a predetermined layout weight. More specifically, the controller 200 may acquire the average of the first layout similarity information and the second layout similarity information as the layout similarity information. However, the present disclosure is not limited thereto, and the predetermined layout weight may give a higher weight to the first layout similarity information or a higher weight to the second layout similarity information. When a higher weight is given to the second layout similarity information, more objective layout similarity information may be acquired, because the second layout similarity information is not acquired based on simple area overlap. However, the present disclosure is not limited thereto.

As described above, since the similarity is derived in an objective way without considering human subjectivity, the user interface comparison apparatus of the present disclosure can objectively compare the UIs of different applications. In particular, by using the layout similarity information of the present disclosure, the structural similarity of different applications can be compared very objectively. The user interface comparison apparatus of the present disclosure protects the rights of developers who have developed original UIs by allowing objective comparison of UIs, and can encourage various UIs to continuously appear in the market.

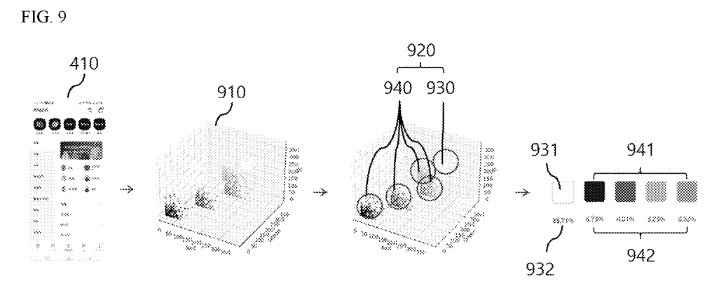

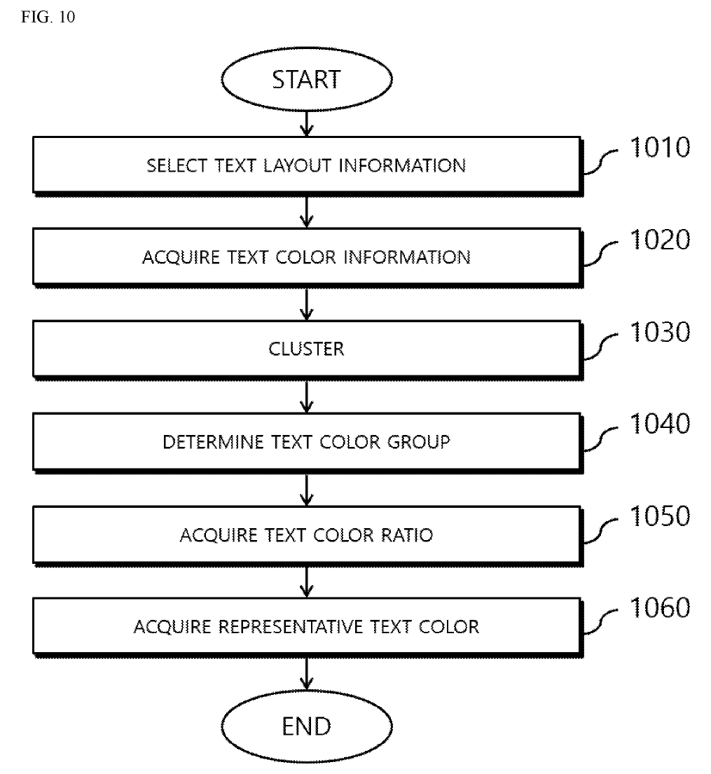

FIG. 8 is a flowchart illustrating an operating method of the user interface comparison apparatus according to an embodiment of the present disclosure. FIG. 9 is a diagram for explaining an operating method of the user interface comparison apparatus according to an embodiment of the present disclosure.

The controller 200 may perform a step 310 of acquiring screen information. Since the step 310 of acquiring the screen information 410 has already been described, redundant description will be omitted.

The controller 200 may perform a step 810 of acquiring color information 910 of a plurality of pixels included in the screen information 410. The screen information 410 may include an image. The screen information 410 may include a plurality of pixels. The controller 200 may acquire pixel values corresponding to each of the plurality of pixels and indicating color values. The controller 200 may acquire a plurality of pixel values for the plurality of pixels. The plurality of pixel values may be color information. The pixel value may be represented in one of RGB, LCrCb, or Lab format.

The controller 200 may display the color information 910 in one space of RGB, LCrCb, or Lab. However, the present disclosure is not limited thereto.

The controller 200 may perform a step 820 of clustering the color information 910 into a plurality of groups 920 of a predetermined number of groups. The controller 200 may cluster the color information using, for example, K-MEANS. However, the present disclosure is not limited thereto, and the controller 200 may cluster the color information based on various algorithms. The controller 200 may acquire the plurality of groups 920 of the predetermined number of groups after clustering. The predetermined number of groups may be, for example, 4 or more and 7 or less. The predetermined number of groups may be 5. The plurality of pixel values included in the color information may be grouped into the plurality of groups 920 based on color. Each group may include pixels included in the screen information 410.

The controller 200 may perform a step 830 of determining a group having a largest number of pixels among the plurality of groups 920 as a background group 930. In addition, the controller 200 may perform a step 840 of determining remaining groups, excluding the background group from the plurality of groups, as at least one main group 940. The controller 200 may perform a step 850 of acquiring a background ratio 932 indicating a ratio of pixels included in the background group among the plurality of pixels. The controller 200 may acquire the background ratio based on a value obtained by dividing the number of pixels included in the background group by the total number of pixels included in the screen information 410. The background ratio 932 may have units of percent.

The controller 200 may perform a step 860 of acquiring a representative background color 931, which is a representative color of the background group. The controller 200 may acquire one of an average value, a mode value, and a median value of the plurality of pixel values included in the background group as the representative background color 931.

The controller 200 may perform a step 870 of acquiring at least one main color ratio 942 indicating a ratio of pixels included in each of the at least one main group among the plurality of pixels. The controller 200 may acquire the at least one main color ratio 942 based on a value obtained by dividing the number of pixels included in one main group by the total number of pixels included in the screen information 410. The at least one main color ratio 942 may have units of percent.

The controller 200 may perform a step 880 of acquiring at least one representative main color 941 by respectively acquiring a representative color of the at least one main group. The controller 200 may acquire one of an average value, a mode value, and a median value of the plurality of pixel values included in one main group as the at least one representative main color 941.

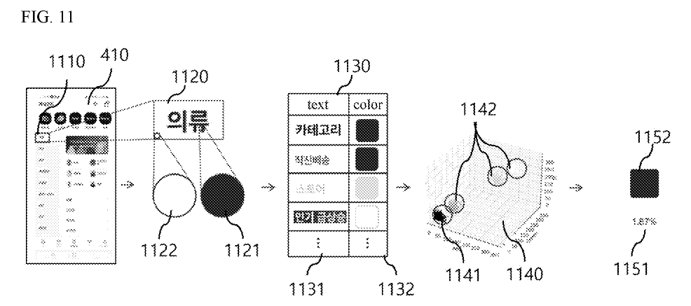

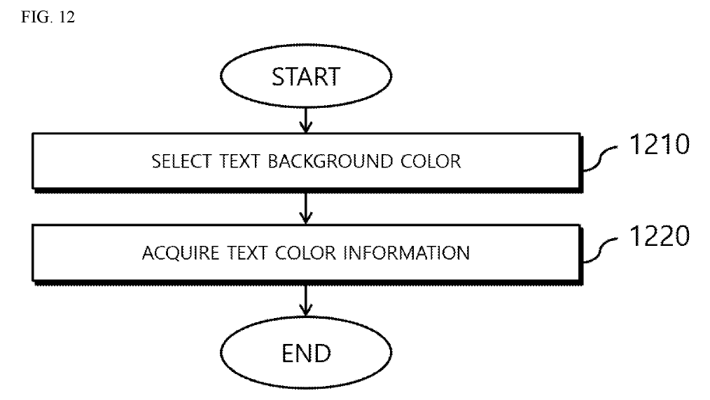

FIG. 10 is a flowchart illustrating an operating method of the user interface comparison apparatus according to an embodiment of the present disclosure. FIG. 11 is a diagram for explaining an operating method of the user interface comparison apparatus according to an embodiment of the present disclosure.

The controller 200 may perform a step 1010 of selecting at least one text layout information 1110 for which a type of item is text from the layout information. The text layout information 1110 may include the location or size of the item.

The controller 200 may perform a step 1020 of acquiring at least one text color information 1121 based on the at least one text layout information. The text color information 1121 may indicate a color used to display text in the screen information 410. The text color information 1121 may indicate a color excluding the text background color 1122 from the area of text 1120.

The step 1020 of acquiring the at least one text color information 1121 will be described in more detail later.

The controller 200 may acquire text color information 1121 for each of a plurality of texts included in the screen information 410 to generate a text color information list 1130. In the text color information list 1130, the content of the text 1131 and the text color information 1132 corresponding to the text may be matched.

In addition, the controller 200 may display the text color information 1121 in one space 1140 of RGB, LCrCb, or Lab. When displaying in the space 1140, all pixels included in the area of text 1120 of one text may be displayed in one space of RGB, LCrCb, or Lab. That is, the controller 200 may display the text color information 1121 and the text background color 1122 included in the area of text 1120 in one space of RGB, LCrCb, or Lab. However, the present disclosure is not limited thereto, and the controller 200 may display only the text color information 1121 included in the area of text 1120 in one space of RGB, LCrCb, or Lab.

The controller 200 may perform a step 1030 of clustering the at least one text color information into a plurality of text area groups 1141, 1142 of a predetermined number of text area groups. The controller 200 may cluster the pixels included in the area of text 1120 of all texts included in the screen information 410. The controller 200 may also cluster only the pixels indicating the text color information 1121 among the area of text 1120. The controller 200 may use the K-MEANS algorithm to perform the clustering step 1030. However, the present disclosure is not limited thereto.

The controller 200 may perform a step 1040 of determining a group having a highest pixel ratio among the plurality of text area groups 1141, 1142 as a text color group 1141. The controller 200 may perform a step 1050 of acquiring a text color ratio indicating a ratio of pixels included in the text color group among the plurality of pixels. The controller 200 may acquire the text color ratio 1151 based on a value obtained by dividing the number of pixels included in the text color group 1141 by the total number of pixels included in the screen information 410. The text color ratio 1151 may have units of percent.

The controller 200 may perform a step 1060 of acquiring a representative text color 1152, which is a representative color of the text color group 1141. The controller 200 may acquire one of an average value, a mode value, and a median value of the plurality of pixel values included in the text color group as the representative text color 1152.

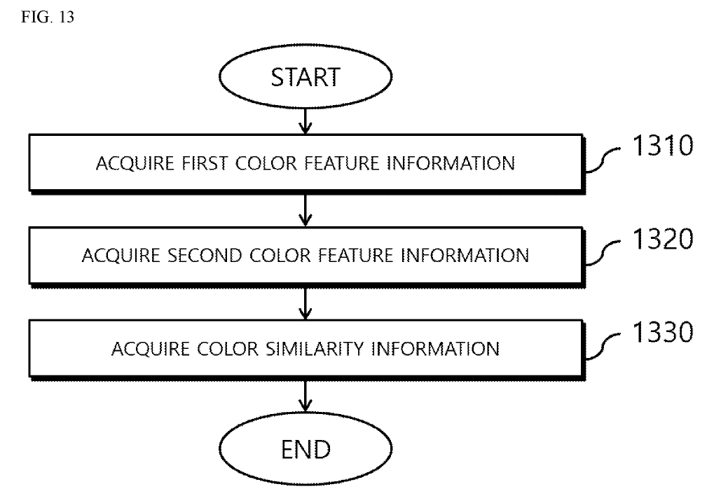

FIG. 12 is a flowchart illustrating an operating method of the user interface comparison apparatus according to an embodiment of the present disclosure.

The step 1020 of acquiring the at least one text color information may include the following steps.

Referring to FIGS. 11 and 12 together, the controller 200 may perform a step 1210 of selecting, based on one text layout information among the at least one text layout information, a color of at least one pixel located at an edge of an area of text 1120 as a text background color 1122. The controller 200 may acquire the text layout information for all texts included in the screen information 410. The controller 200 may select one area of text 1120 based on one text layout information. The controller 200 may select the color of at least one pixel located at an edge in the selected area of text 1120 as the text background color 1122. The controller 200 may determine the pixel value of the pixel at least one location of the lower-left, lower-right, upper-left, or upper-right among the area of text 1120 as the text background color 1122. However, the present disclosure is not limited thereto, and the controller may determine the pixel value of the pixel at a predetermined location located at the edge of the area of text 1120 as the text background color 1122.

The controller 200 may perform a step 1220 of acquiring a color having a highest ratio, excluding the text background color, from the area of the text 1120 as the text color information 1121. The controller 200 may acquire the text color information 1121 for the area of all texts included in the screen information 410. The controller 200 may acquire the text color information 1121 for the area of all texts to generate the text color information list 1130.

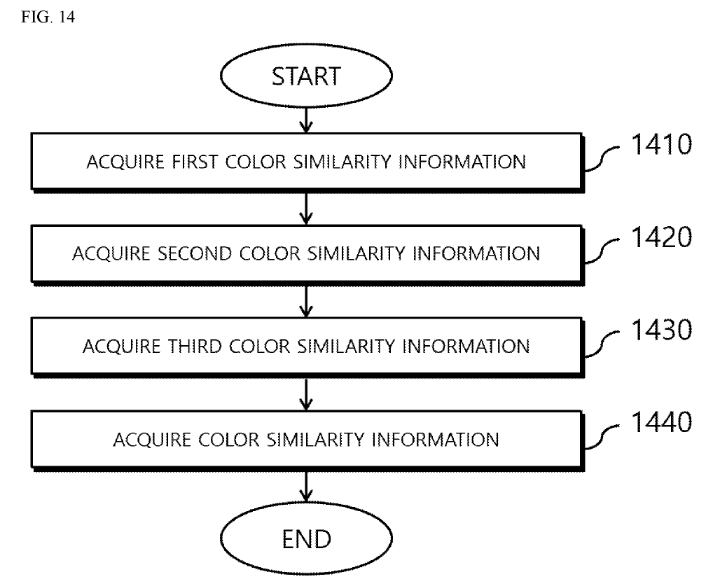

FIG. 13 is a flowchart for explaining an operation of the user interface comparison apparatus according to an embodiment of the present disclosure.

The controller 200 may compare the UIs of two applications based on color.

Referring to FIG. 13, the controller 200 may perform a step 1310 of acquiring the background ratio, the representative background color, the at least one main color ratio, the at least one representative main color, the text color ratio, and the representative text color for the application as first color feature information. In addition, the controller 200 may perform a step 1320 of acquiring background ratio, representative background color, at least one main color ratio, at least one representative main color, text color ratio, and representative text color for the different application as second color feature information. The process of generating the background ratio, the representative background color, the at least one main color ratio, the at least one representative main color, the text color ratio, and the representative text color has already been described, so redundant description will be omitted.

The controller 200 may perform a step 1330 of acquiring color similarity information based on the first color feature information and the second color feature information. The controller 200 may acquire the color similarity information after converting the colors included in the first color feature information and the second color feature information into the Lab color space. The controller 200 may acquire the color similarity information based on at least one of CIE76, CIE94, or CIEDE2000.

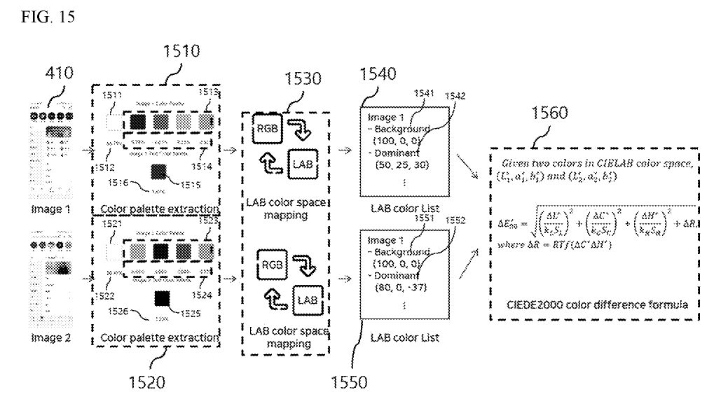

Referring to FIG. 14 to describe the process of acquiring the color similarity information.

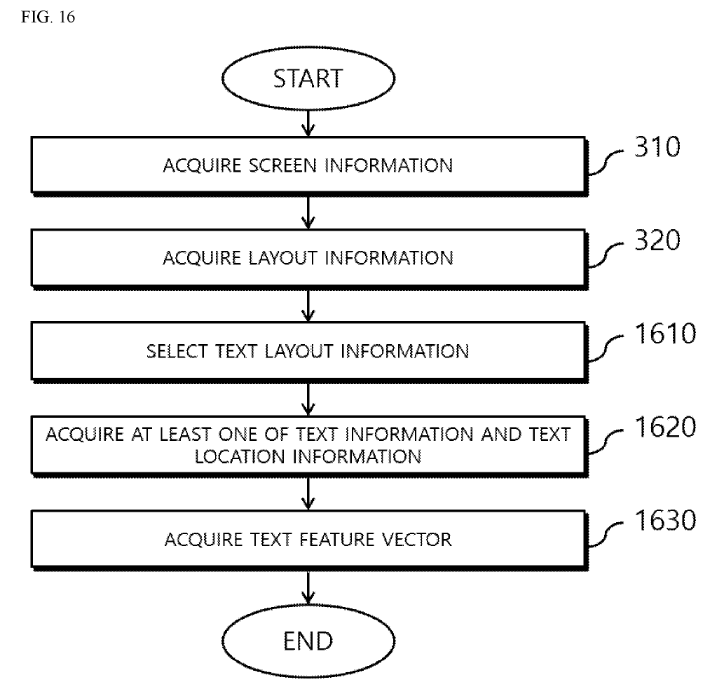

FIG. 14 is a flowchart for explaining an operation of the user interface comparison apparatus according to an embodiment of the present disclosure. FIG. 15 is a diagram for explaining an operation of the user interface comparison apparatus according to an embodiment of the present disclosure.

The step 1330 of acquiring the color similarity information may include the following steps.

The controller 200 may perform a step 1410 of acquiring first color similarity information by comparing at least one of the background ratio 1512 and the representative background color 1511 included in the first color feature information 1510 with at least one of the background ratio 1522 and the representative background color 1521 included in the second color feature information 1520. The controller 200 may acquire the first color similarity information based on at least one of CIE76, CIE94, or CIEDE2000. When performing step 1410, the controller 200 may acquire a first color information list 1540 and a second color information list 1550 by converting 1530 the first color feature information 1510 and the second color feature information 1520 into the Lab color space. The first color information list 1540 may include the representative background color 1541 modified into the Lab color space. The second color information list 1550 may include the representative background color 1551 modified into the Lab color space. The controller 200 may perform the step 1410 of acquiring the first color similarity information by comparing 1560 the modified representative background color 1541 and the modified representative background color 1551.

The controller 200 may perform a step 1420 of acquiring second color similarity information by comparing at least one of the at least one main color ratio 1514 and the at least one representative main color 1513 included in the first color feature information with at least one of the at least one main color ratio 1524 and the at least one representative main color 1523 included in the second color feature information. The controller 200 may acquire the second color similarity information based on at least one of CIE76, CIE94, or CIEDE2000. The first color information list 1540 may include the at least one representative main color 1542 modified into the Lab color space. The second color information list 1550 may include the at least one representative main color 1552 modified into the Lab color space. The controller 200 may perform the step 1420 of acquiring the second color similarity information by comparing 1560 the modified at least one representative main color 1542 and the modified at least one representative main color 1552.

The at least one main color ratio and the at least one representative main color included in the first color feature information may be plural. In addition, the at least one main color ratio and the at least one representative main color included in the second color feature information may be plural. The controller 200 may acquire a plurality of sub-color similarities by comparing all the at least one main color ratio and the at least one representative main color included in the first color feature information with all the at least one main color ratio and the at least one representative main color included in the second color feature information. The controller 200 may acquire the second color similarity information by averaging the acquired plurality of sub-color similarities.

However, the present disclosure is not limited thereto, and the controller 200 may acquire a plurality of sub-color similarities by comparing the at least one main color ratio and the at least one representative main color included in the first color feature information with the at least one main color ratio and the at least one representative main color included in the second color feature information based on the ratio. For example, the controller 200 may acquire a plurality of sub-color similarities by comparing the main color ratio and the representative main color of the N-th rank ratio included in the first color feature information with the main color ratio and the representative main color of the N-th rank ratio included in the second color feature information. The number of the plurality of sub-color similarities may be N. The controller 200 may acquire the second color similarity information by averaging the acquired plurality of sub-color similarities. However, the present disclosure is not limited thereto.

The controller 200 may perform a step 1430 of acquiring third color similarity information by comparing at least one of the text color ratio 1516 and the representative text color 1515 included in the first color feature information with at least one of the text color ratio 1526 and the representative text color 1525 included in the second color feature information. The controller 200 may acquire the third color similarity information based on at least one of CIE76, CIE94, or CIEDE2000. The first color information list 1540 may include the representative text color (not shown) modified into the Lab color space. The second color information list 1550 may include the representative text color (not shown) modified into the Lab color space. The controller 200 may perform the step 1430 of acquiring the third color similarity information by comparing 1560 the modified representative text color and the modified representative text color.

The controller 200 may perform a step 1440 of acquiring the color similarity information by calculating a weighted average of the first color similarity information, the second color similarity information, and the third color similarity information with a predetermined color weight. For example, the predetermined color weight for the first color similarity information may be 15%, the color weight for the second color similarity information may be 70%, and the color weight for the third color similarity information may be 15%. However, the present disclosure is not limited thereto.

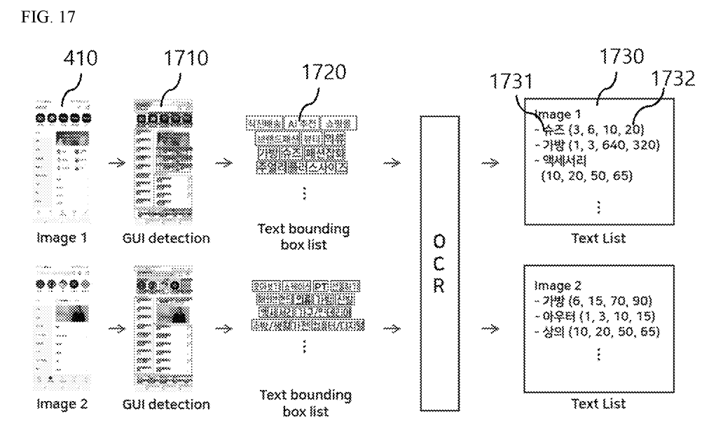

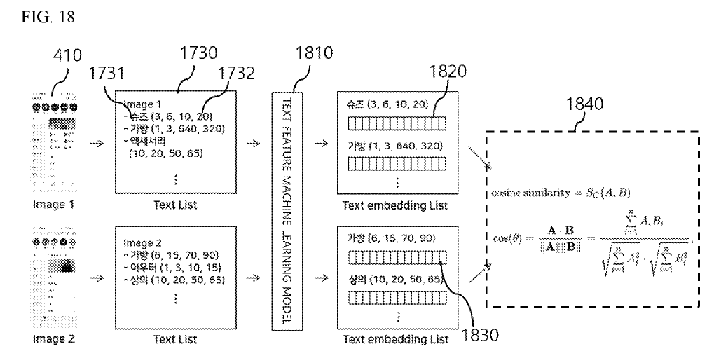

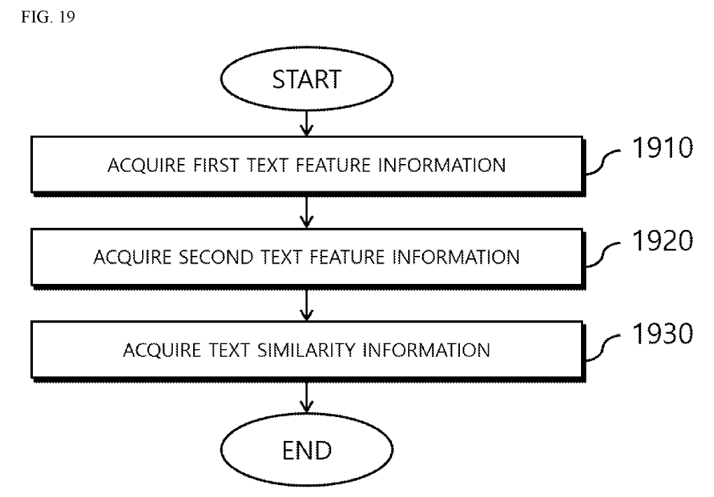

FIG. 16 is a flowchart illustrating an operating method of the user interface comparison apparatus according to an embodiment of the present disclosure. FIG. 17 is a diagram for explaining an operating method of the user interface comparison apparatus according to an embodiment of the present disclosure. FIG. 18 is a diagram for explaining an operating method of the user interface comparison apparatus according to an embodiment of the present disclosure.

The controller 200 may perform a step 310 of acquiring screen information 410 of a user interface displayed on an application screen. In addition, the controller 200 may perform a step 320 of acquiring layout information including at least one of a location, a size, or a type of at least one item included in the screen information 410.

Since step 310 and step 320 have already been described, redundant description will be omitted.

Referring to FIG. 16, the controller 200 may perform a step 1610 of selecting text layout information for which a type of item is text from the layout information. The controller 200 may perform a step 1620 of acquiring at least one of text information 1731 and text location information 1732 based on the text layout information. The text layout information may include at least one of text location information or size information. The controller 200 may acquire the text information based on at least one of the text location information or the size information included in the text layout information.

Referring to FIG. 17 to explain step 1610 and step 1620.

The controller 200 may acquire at least one bounding box from the screen information 410 based on the text layout information. The screen information 410 including the at least one bounding box is shown in the drawing 1710.

The controller 200 may acquire the text inside the at least one bounding box. The controller 200 may acquire the text from the screen information expressed in HTML or XML. However, the present disclosure is not limited thereto. The screen information may be an image. The controller 200 may acquire an image inside the at least one bounding box from the screen information. Acquiring the image inside the at least one bounding box is shown in the drawing 1720. The controller 200 may acquire the at least one of text information 1731 and text location information 1732 by applying the image inside the at least one bounding box to an OCR (Optical Character Recognition) algorithm. The text information 1731 may mean text recognized within the bounding box. The text location information 1732 may indicate at least one of the upper-left coordinate or the lower-right coordinate of the bounding box in the screen information 410. The controller 200 may acquire the text information 1731 and the text location information 1732 for all texts included in the screen information 410, and the set of the text information 1731 and the text location information 1732 may be referred to as a text information list 1730.

Referring to FIGS. 16 and 18, the controller 200 may perform a step 1630 of acquiring a text feature vector 1820 based on the at least one of the text information 1731 and the text location information 1732. The controller 200 may acquire the text feature vector 1820 based on a text feature machine learning model 1810. The text feature machine learning model 1810 may be based on an autoencoder. The text feature machine learning model 1810 may be based on RoBERTa. The text feature vector 1820 may be a unique value indicating at least one of the text information 1731 and the text location information 1732. In addition, the text feature vector 1820 may have a smaller capacity than at least one of the text information 1731 and the text location information 1732.

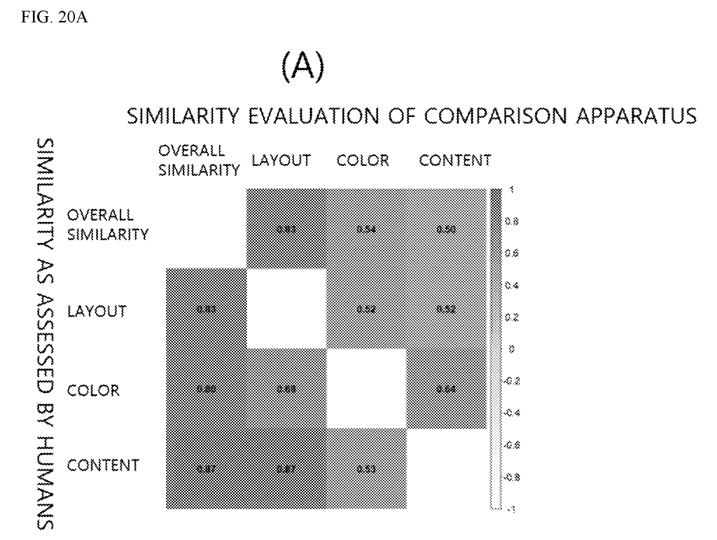

FIG. 19 is a flowchart illustrating an operating method of the user interface comparison apparatus according to an embodiment of the present disclosure.

Referring to FIGS. 18 and 19, the controller 200 may perform a step 1910 of acquiring the text feature vector 1820 for the application as first text feature information. The controller 200 may perform a step 1920 of acquiring a text feature vector for the different application as second text feature information 1830. The controller 200 may perform a step 1930 of acquiring text similarity information based on the first text feature information and the second text feature information. The controller 200 may compare the first text feature information and the second text feature information using a cosine similarity comparison 1840 and acquire the text similarity information.

As described above, the controller 200 may acquire layout similarity information, color similarity information, and text similarity information. The controller 200 may determine final similarity information of the application and the different application based on at least one of the layout similarity information, the color similarity information, and the text similarity information. The controller 200 may perform a step of determining final similarity information of the application and the different application by calculating a weighted average of the layout similarity information, the color similarity information, and the text similarity information with a predetermined final weight. The layout similarity information may be greater than the color similarity information and the text similarity information. For example, the predetermined final weight for the layout similarity information may be 0.6, the final weight for the color similarity information may be 0.2, and the final weight for the text similarity information may be 0.2. However, the present disclosure is not limited thereto. The weight for at least one of the layout similarity information, the color similarity information, and the text similarity information may be 0. That is, at least one of the layout similarity information, the color similarity information, and the text similarity information may not affect the final similarity information. For example, the text similarity information may not affect the final similarity information.

The user interface comparison apparatus of the present disclosure considers all of the main components of a UI, namely layout, color, and text, and thus can objectively and accurately compare two UIs. In particular, by making the layout similarity information, which has a great influence on the user, greater than the color similarity information and the text similarity information, the similarity of the UI felt by the user can be expressed as an objective indicator. Therefore, by objectively comparing UIs using the user interface comparison apparatus of the present disclosure, people who copy UIs as they are can feel pressured, and thus, the practice of copying UIs as they are can be eradicated. In addition, the user interface comparison apparatus of the present disclosure can contribute to the development of unique and convenient UIs by vitalizing attempts at unique UIs.

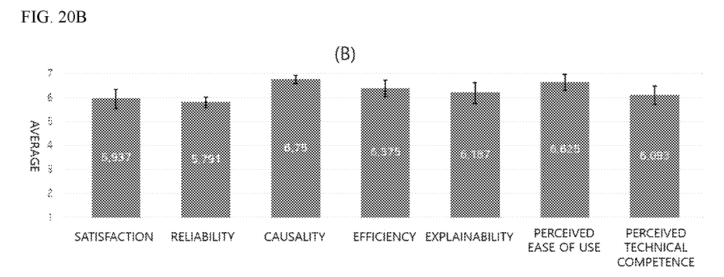

FIGS. 20A and 20B are diagrams for showing the effects of the user interface comparison apparatus according to an embodiment of the present disclosure.

Referring to FIG. 20A, it can be seen that human-rated similarity and the similarity of the user interface comparison apparatus have a high correlation. In particular, it was confirmed that the layout similarity information and the color similarity information have a large correlation with user evaluation. Therefore, it can be seen that the user interface comparison apparatus of the present disclosure objectively evaluates the similarity of UIs.

Referring to FIG. 20B, a survey was conducted on the user's experience using the user interface comparison apparatus. The respondents to the survey were 8 adult men and women with 6 months or more of mobile app UI design experience. In addition, the respondents to the survey were people with no abnormalities in color vision. As a result, evaluation results of 5.5 or higher on average were obtained in terms of satisfaction, reliability, causality, efficiency, explicability, perceived ease of use, and perceived technical competence of the user interface comparison apparatus. Therefore, it can be seen that the user interface comparison apparatus of the present disclosure provided a positive experience to users.

So far, various embodiments have been mainly examined. Those of ordinary skill in the art to which the present invention pertains will understand that the present invention can be implemented in modified forms without departing from the essential characteristics of the present invention. Therefore, the disclosed embodiments should be considered in an illustrative point of view rather than a limiting point of view. The scope of the present invention is shown in the claims rather than the foregoing description, and all differences within the equivalent scope should be interpreted as being included in the present invention.

Meanwhile, the above-described embodiments of the present invention can be written as programs that can be executed on a computer, and can be implemented in a general-purpose digital computer that operates the program using a computer-readable recording medium. The computer-readable recording medium includes storage media such as magnetic storage media (e.g., ROM, floppy disk, hard disk, etc.), optical reading media (e.g., CD-ROM, DVD, etc.).

What is claimed is:

1. An operating method of a user interface comparison apparatus including a controller, the operating method comprising:
acquiring, by the controller, screen information of a user interface displayed on an application screen;
acquiring layout information including at least one of a location, a size, or a type of at least one item included in the screen information;
acquiring a layout feature vector based on the layout information;
acquiring first layout feature information, for the application, including the layout information and the layout feature vector;
acquiring second layout feature information based on a different application screen from the application; and
acquiring layout similarity information based on the first layout feature information and the second layout feature information.

2. The operating method of claim 1,
wherein the acquiring the layout information comprises:
acquiring the layout information by applying the screen information, which includes a capture image of the application screen, to a layout machine learning model, and
the acquiring the layout feature vector comprises:
acquiring the layout feature vector by applying the layout information to a feature determination machine learning model.

3. The operating method of claim 2,
wherein the layout machine learning model is a YOLO-based machine learning model, and
the feature determination machine learning model is an autoencoder-based machine learning model.

4. The operating method of claim 1,
wherein the acquiring the layout similarity information based on the first layout feature information and the second layout feature information comprises:
acquiring first layout similarity information by comparing layout information included in the first layout feature information and layout information included in the second layout feature information;
acquiring second layout similarity information by comparing a feature vector included in the first layout feature information and a feature vector included in the second layout feature information; and
acquiring the layout similarity information by calculating a weighted average of the first layout similarity information and the second layout similarity information with a predetermined layout weight.

5. The operating method of claim 1, further comprising:
acquiring color information of a plurality of pixels included in the screen information;
clustering the color information into a plurality of groups of a predetermined number of groups;
determining a group having a largest number of pixels among the plurality of groups as a background group;
determining remaining groups, excluding the background group from the plurality of groups, as at least one main group;
acquiring a background ratio indicating a ratio of pixels included in the background group among the plurality of pixels;
acquiring a representative background color, which is a representative color of the background group;
acquiring at least one main color ratio indicating a ratio of pixels included in each of the at least one main group among the plurality of pixels; and
acquiring at least one representative main color by respectively acquiring a representative color of the at least one main group.

6. The operating method of claim 5, further comprising:
selecting at least one text layout information for which a type of item is text from the layout information;
acquiring at least one text color information based on the at least one text layout information;
clustering the at least one text color information into a plurality of text area groups of a predetermined number of text area groups;
determining a group having a highest pixel ratio among the plurality of text area groups as a text color group;
acquiring a text color ratio indicating a ratio of pixels included in the text color group among the plurality of pixels; and
acquiring a representative text color, which is a representative color of the text color group.

7. The operating method of claim 6,
wherein the acquiring the at least one text color information comprises:
selecting, based on one text layout information among the at least one text layout information, a color of at least one pixel located at an edge of an area of text as a text background color; and
acquiring a color having a highest ratio, excluding the text background color, from the area of the text as the text color information.

8. The operating method of claim 6, further comprising:
acquiring the background ratio, the representative background color, the at least one main color ratio, the at least one representative main color, the text color ratio, and the representative text color for the application as first color feature information;
acquiring background ratio, representative background color, at least one main color ratio, at least one representative main color, text color ratio, and representative text color for the different application as second color feature information; and
acquiring color similarity information based on the first color feature information and the second color feature information.

9. The operating method of claim 8,
wherein the acquiring the color similarity information comprises:
acquiring first color similarity information by comparing at least one of the background ratio and the representative background color included in the first color feature information with at least one of the background ratio and the representative background color included in the second color feature information;
acquiring second color similarity information by comparing at least one of the at least one main color ratio and the at least one representative main color included in the first color feature information with at least one of the at least one main color ratio and the at least one representative main color included in the second color feature information;
acquiring third color similarity information by comparing at least one of the text color ratio and the representative text color included in the first color feature information with at least one of the text color ratio and the representative text color included in the second color feature information; and
acquiring the color similarity information by calculating a weighted average of the first color similarity information, the second color similarity information, and the third color similarity information with a predetermined color weight.

10. The operating method of claim 1, further comprising:
selecting text layout information for which a type of item is text from the layout information;
acquiring at least one of text information and text location information based on the text layout information; and
acquiring a text feature vector based on the at least one of the text information and the text location information.

11. The operating method of claim 10, further comprising:
acquiring the text feature vector for the application as first text feature information;
acquiring a text feature vector for the different application as second text feature information; and
acquiring text similarity information based on the first text feature information and the second text feature information.

12. The operating method of claim 8, further comprising:
determining final similarity information of the application and the different application by calculating a weighted average of the layout similarity information, the color similarity information, and text similarity information with a predetermined final weight.

13. An operating method of a user interface comparison apparatus including a controller, the operating method comprising:
acquiring, by the controller, screen information of a user interface displayed on an application screen;
acquiring color information of a plurality of pixels included in the screen information;
clustering the color information into a plurality of groups of a predetermined number of groups;
determining a group having a largest number of pixels among the plurality of groups as a background group;
determining remaining groups, excluding the background group from the plurality of groups, as at least one main group;
acquiring a background ratio indicating a ratio of pixels included in the background group among the plurality of pixels;
acquiring a representative background color, which is a representative color of the background group;
acquiring at least one main color ratio indicating a ratio of pixels included in each of the at least one main group among the plurality of pixels; and
acquiring at least one representative main color by respectively acquiring a representative color of the at least one main group.

14. An operating method of a user interface comparison apparatus including a controller, the operating method comprising:
acquiring, by the controller, screen information of a user interface displayed on an application screen;
acquiring layout information including at least one of a location, a size, or a type of at least one item included in the screen information;
selecting text layout information for which a type of item is text from the layout information;
acquiring at least one of text information and text location information based on the text layout information; and
acquiring a text feature vector based on the at least one of the text information and the text location information.
